(19) United States
(12) Patent Application Publication
(10) Pub. No.: US 2005/0105218 A1
(43) Pub. Date: May 19, 2005

(54) Method and apparatus controlling communication in the main flex and bridge flex circuits for multiple micro-actuators in a hard disk drive

(76) Inventors: Vinod Sharma, Los Gatos, CA (US); Hyung Jai Lee, Cupertino, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/713,616

(22) Filed: Nov. 13, 2003

(51) Int. Cl. G11B 5/48; G11B 21/16

(52) U.S. Cl. 360/245.9

(57) ABSTRACT

The present invention includes communication between a servo-controller and micro-actuators, which position multiple read-write heads, which occurs through sharing a bundle of wires with the micro-actuators. The invention is applicable to disk drives including both hard disk drives and optical disk drives. When accessing a disk surface, all micro-actuators perform the same positioning, insuring the proper positioning of the read-write head above the accessed disk surface. The invention applies to co-located and/or non co-located micro-actuators. The wire bundle may include one or two active signal wires. The invention includes a flex circuitry assembly implementing the communication, a voice coil actuator built with the flex circuitry, and a hard disk drive built with the voice coil actuator, as well as the methods of making these components.

### BACKGROUND OF THE INVENTION

1. Field of the Invention

The present invention relates to flex circuitry used in the control of multiple micro-actuators in a hard disk drive.

2. Background Information

Modern disk drives include a servo controller driving a voice coil actuator to position a read-write head near a track on a rotating disk surface. The read-write head communicates with the servo controller, providing feedback, which is used in controlling the read-write head's positioning near the track.

A voice coil actuator typically includes a voice coil that swings at least one actuator arm in response to the servo controller. Each actuator arm includes at least one head gimbal assembly typically containing a read-write head embedded in a slider. The slider rides on a thin air bearing a short distance off the rotating disk surface, and mechanically couples through a load beam to the actuator arm in the voice coil actuator.

A hard disk drive may have one or more disks, and each of the disks may have up to two disk surfaces in use. Each disk surface in use has an associated slider, with the necessary actuator arm. Hard disk drives typically have only one voice coil actuator.

Today, the bandwidth of the servo controller feedback loop, or servo bandwidth, is typically in the range of 1.1K Hz.

Extending servo bandwidth, increases the sensitivity of the servo controller to drive the voice coil actuator to ever finer track positioning. Additionally, it decreases the time for the voice coil actuator to change track positions.

However, extending servo bandwidth is difficult, and has not significantly improved in years. As track densities increase, the need to improve track positioning increases.

One answer to this need involves integrating a micro-actuator into each head gimbal assembly. These micro-actuators are devices typically built of piezoelectric composite materials, often involving lead, zirconium, and titanium. The piezoelectric effect generates a mechanical action through the application of electric power. The piezoelectric effect of the micro-actuator, acting through a lever between the slider and the actuator arm, moves the read-write head over the tracks of a rotating disk surface.

The micro-actuator is typically controlled by the servo-controller through one or two wires. Electrically stimulating the micro-actuator through the wires triggers mechanical motion due to the piezoelectric effect. The micro-actuator adds fine positioning capabilities to the voice coil actuator, which effectively extends the servo bandwidth. The single wire approach to controlling one micro-actuator provides a AC (alternating current) voltage to one of the two leads of the piezoelectric element. The other lead is tied to a shared ground. The two wire approach drives both leads of one micro-actuator.

There are two approaches to integrating the micro-actuator into a head gimbal assembly. Embedding the micro-actuator between the slider and the load beam, creates a co-located micro-actuator. Embedding the micro-actuator into the load beam, creates a non co-located micro-actuator. The non co-located micro-actuators tend to consume more power, requiring higher driving voltages than the co-located micro-actuators.

A problem arises when integrating micro-actuators into hard disk drives with multiple disk surfaces. Each of the micro-actuators requires its leads to be controlled by the servo-controller. These leads are coupled to wires, which must traverse the bridge flex circuit or the long tail portion of the long tail suspension to get to the main flex circuit. The bridge flex circuit provides electrical coupling to the leads of the micro-actuator.

The main flex circuit constrains many components of the actuator arm assembly within a voice coil actuator. If the shape or area of the main flex circuit is enlarged, changes are required to many of the components of the actuator arm assembly and possibly the entire voice coil actuator. Changing many or most of the components of an actuator arm assembly, leads to increases in development expenses, retesting and recalibrating the production processes for reliability, and inherently increases the cost of production.

The existing shape and surface area of the main flex circuit has been extensively optimized for pre-existing requirements. There is no room in the main flex circuit to run separate control wires to each micro-actuator for multiple disk surfaces. This has limited the use of micro-actuators to hard disk drives with only one active disk surface.

What is needed is a way to integrate micro-actuators into multiple disk surface disk drives using the existing surface area and shape of the main flex circuit.

### BRIEF SUMMARY OF THE INVENTION

The present invention includes communication between the servo-controller and the micro-actuators, which position multiple read-write heads. The communication occurs through sharing a bundle of wires with all the micro-actuators. The invention is applicable to disk drives including both hard disk drives and optical disk drives. Many preferred embodiments focus on the hard disk drive, and the discussion from hereon will focus specifically on these disk drives. This discloses the preferred embodiment of the invention as of the time of filing, and is not intended to limit the scope of the claims.

When accessing a disk surface, all the micro-actuators perform the same positioning action, insuring proper positioning of the read-write head in the slider above the accessed disk surface. The invention applies equally to co-located and non co-located micro-actuators. The wire bundle may include one active signal wire or two active signal wires.

The invention is cost effective and reliable, offering the advantages of micro-actuators in multiple surface disk drives, without disrupting the overall design of the voice coil actuator. These advantages include an increase in servo bandwidth from about 1.1 K Hz to over 2.6 K Hz.

The invention includes the flex circuitry assembly implementing the communication, the voice coil actuator built with the flex circuitry, and the hard disk drives built with the voice coil actuators, as well as the methods of making these components.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 shows communication within a hard disk drive between a servo-controller and one or more micro-actuators for positioning multiple sliders, with a micro-actuator control bundle of two wires shared with the micro-actuators;

FIG. 2 shows the communication as in FIG. 1, sharing the micro-actuator bundle of one wire with all of the micro-actuators;

FIG. 3A shows a voice coil actuator of the hard disk drive of FIGS. 1 and 2, including a main flex circuit of the invention;

FIG. 3B shows a preferred embodiment of the main flex circuit of FIG. 3A;

FIG. 3C shows an enlargement of the region of the main flex circuit housing the preamplifier and providing the coupling interfaces to bridge flex circuits;

FIG. 4A shows a preferred, bridge flex circuit providing a matching coupling interface to the main flex circuit of FIGS. 3B and 3C; and

FIG. 4B shows an enlargement of the matching coupling interface of FIG. 4A;

FIG. 4C shows a mirrored embodiment of the bridge flex circuit of FIG. 4A; and

FIG. 4D shows an enlargement of the matching coupling interface of FIG. 4C.

### DESCRIPTION OF THE PREFERRED EMBODIMENTS

The following description is provided to enable any person skilled in the art to make and use the invention and sets forth the best modes presently contemplated by the inventors for carrying out the invention. Various modifications, however, will remain readily apparent to those skilled in the art, since the generic principles of the present invention have been defined herein.

Leads of a micro-actuator stimulating a piezoelectric effect are the control bundle of the micro-actuator. When a single approach is used, the control bundle has one wire. When a two wire approach is used, the control bundle has two wires.

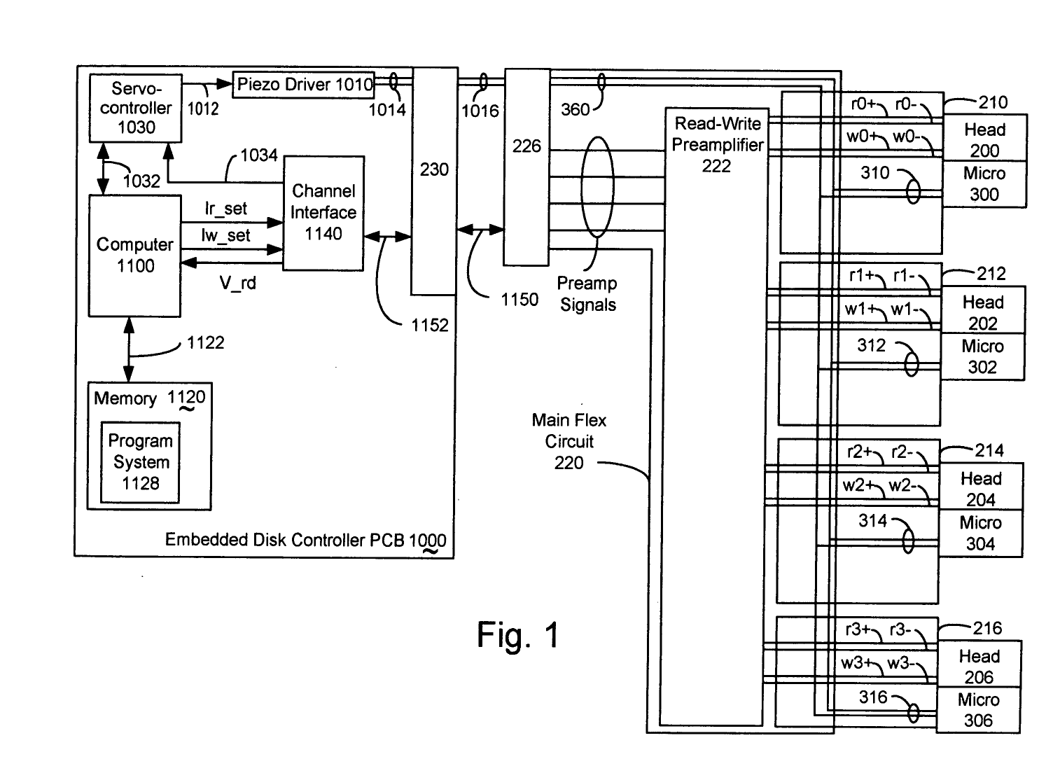

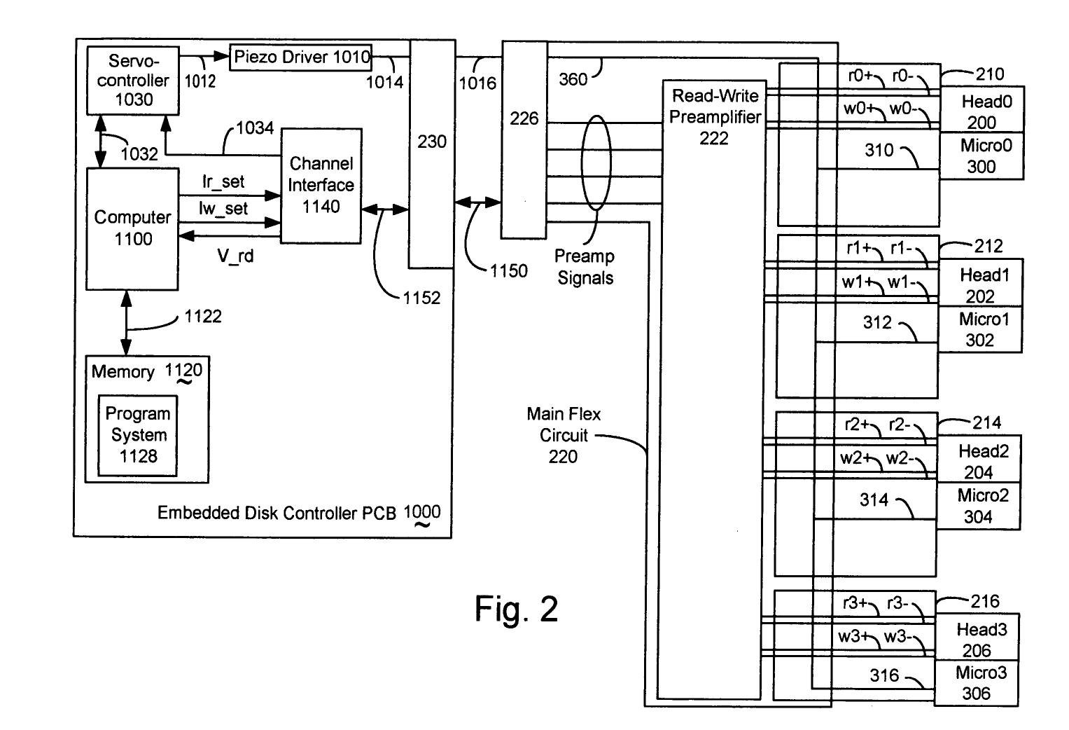

The invention includes a communication mechanism shown in FIGS. 1 and 2, between a servo-controller 1030 and micro-actuators 300-306 that position multiple read-write heads 200-206. The communication mechanism includes a main flex circuit 220 receiving a control wire bundle 1014 via a ribbon cable bundle 1016. The ribbon cable bundle 1016 is received at ribbon cable connector 226 to create the signal states on a source control bundle 360 in the main flex circuit 220. The source control bundle 360 is shared through a bridge flex circuit. The communication mechanism further includes the main flex circuit 220 coupled with at least two of bridge flex circuits 210-216.

In FIG. 1, the source control bundle 360 involves two wires carrying active signals. In FIG. 2, the source control bundle 360 involves just one wire carrying an active signal, and in FIG. 2, the second lead of the micro-actuators 300-306 are tied to a shared ground.

Micro-actuator 300 positions the read-write head 200 in FIGS. 1 and 2. The bridge flex circuit 210 couples the micro-actuator 300 and the read-write head 200 to the main flex circuit 220. This includes coupling the source control bundle 360 of the main flex circuit 220 to the micro-actuator control bundle 310 for the micro-actuator 300.

Similarly, bridge flex circuit 212 couples the source control bundle 360 to a micro-actuator control bundle 312 for the micro-actuator 302, in FIGS. 1 and 2. Bridge flex circuit 214 couples the source control bundle 360 to the micro-actuator control bundle 314 for micro-actuator 304. The bridge flex circuit 216 couples the source control bundle 360 to the micro-actuator control bundle 316 for micro-actuator 306.

In FIGS. 1 and 2, the servo-controller 1030 controls a piezo driver 1010, which drives wire bundle 1014, in the embedded disk controller printed circuit board 1000. The wire bundle 1014 connects to a ribbon cable connector 230. The ribbon cable connector 230 connects via a ribbon cable 1150 to a ribbon cable connector 226 of the main flex circuit 220. Ribbon cable 1150 includes wire bundle 1016, which interconnects wire bundle 1014 with the source control bundle 360, in the main flex circuit 220.

The micro-actuators 300-306 may be non co-located with their respective read-write heads 200-206 of FIGS. 1 and 2. However, it is currently preferred that they be co-located, as this tends to reduce the voltage requirements for the piezo driver 1010.

When the invention is in operation, and the disk drive is accessing a disk surface, all the micro-actuators 300-306 perform the same positioning action on their respective read-write heads. This insures proper positioning of the read-write head in the slider above the accessed disk surface.

The invention offers the advantages of using micro-actuators for each surface of a multiple surface, hard disk drive. By not disrupting the overall design of the voice coil actuator, the invention promotes cost efficiencies. The invention further promotes reliability by allowing the use of voice coil actuator components already in production. Using the micro-actuators increases the servo bandwidth from about 1.1 K Hz to over 2.6 K Hz.

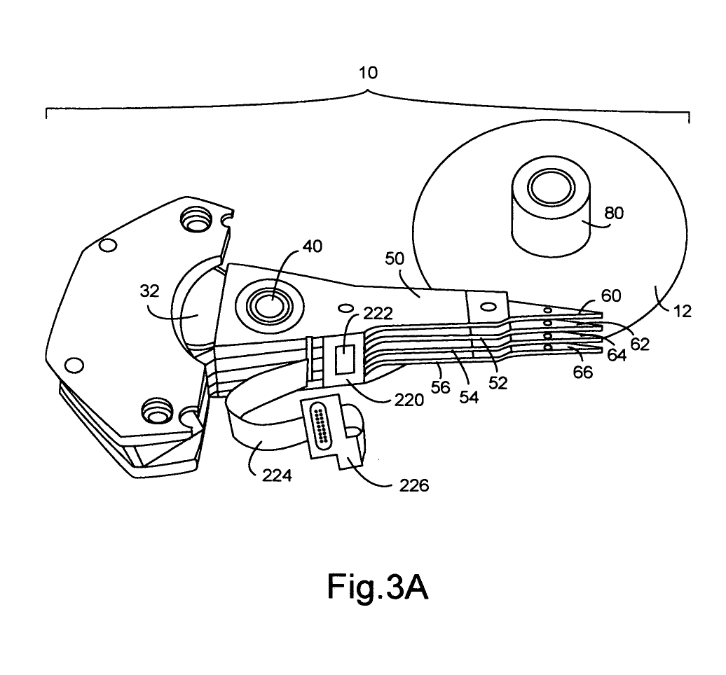

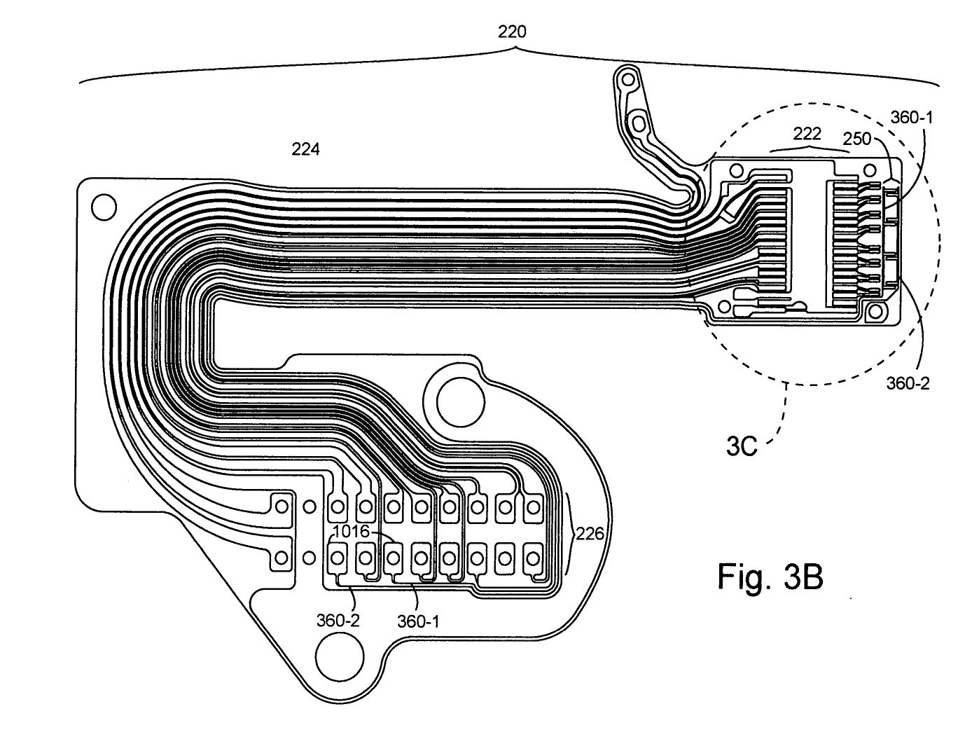

The invention includes a voice coil actuator shown in FIG. 3A built with the flex circuitry 220, and the hard disk drives 10 built with the voice coil actuators. The voice coil actuator includes an assembly of at least one actuator arm 50, and as shown, additional actuator arms 52, 54 and 56. A disk surface 12 is shown, which when the invention is in operation, rotates about a spindle 80. The invention applies to hard disk drives with at least one disk surface supplied with micro-actuators to aid in positioning the read-write heads. The read-write heads and micro-actuators are located near points of head gimbal assemblies 60 to 66.

The main flex circuit 220 of FIGS. 1-3B includes a ribbon cable socket 226, providing preamplifier signals to a read-write preamplifier site 222. The ribbon cable socket 226 also provides a source control bundle 360, shared with the control wire bundles 310-316 of the bridge flex circuits 210-216. The ribbon cable socket 226 is coupled via flex region 224 to a preamplifier site 222 and a bridge coupling region 250.

The preamplifier 222 and the coupling of the preamplifier of the differential read and write signals to the bridge flex circuits is one of the main constraints for the main flex circuit 220 and impacts many of the components of the actuator arm assembly as shown in FIG. 3A.

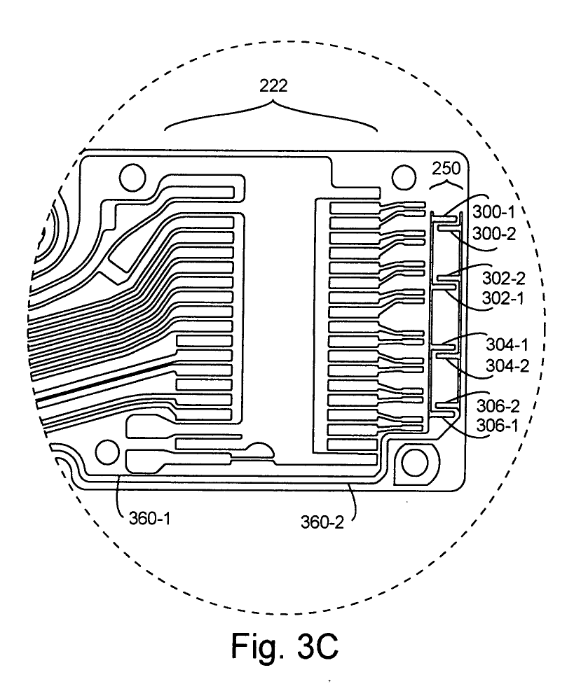

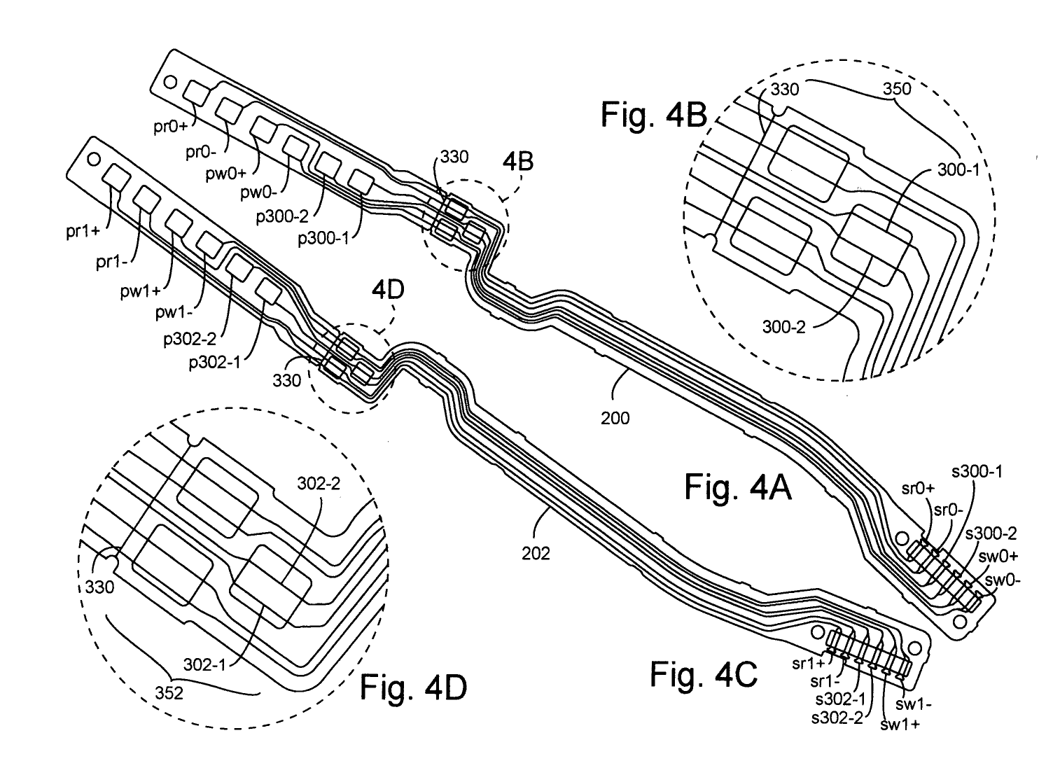

FIG. 4A shows a bridge flex circuit 310 with a test strip providing a probe point for each of the control signal bundle, the read differential signal pair, and the write differential signal pair. The test strip is only used during initial test of the bridge flex circuit, and is removed before the coupling of the bridge flex circuit with the main flex circuit.

The test strip probe points of FIG. 4A for the control signal bundle 310, which includes signals 310-1 and 310-2 are labeled p310-1 and p310-2, respectively.

The test strip probe points of FIG. 4A for the read differential signal pair, which includes r0+ and r0− are labeled pr0+ and pr0−, respectively.

The test strip probe points of FIG. 4A for the write differential signal pair, which includes w0+ and w0− are labeled pw0+ and pw0−, respectively.

The bridge flex circuit 310 of FIG. 4A also provides contacts for a slider containing the read-write head for the read differential signal pair, and the write differential signal pair, as sr0+, sr0−, sw0+, and sw0−. One skilled in the art will recognize that the exact order of these signal contacts will vary with different implementations, and any ordering is potentially preferred as the situation varies.

The bridge flex circuit 310 of FIG. 4A also provides contacts for the control signal bundle to the micro-actuator as s310-1 and s310-2. In embodiments using a one wire approach, the control signal bundle would have one wire, with only one contact.

FIG. 4B shows an enlargement of the coupling site 350 of the bridge flex circuit 310 of FIGS. 1, 2, and 4A for the control signal bundle c310-1 and c310-2.

FIG. 4C is the mirror image of FIG. 4A, and shows the bridge flex circuit 212. The mirror bridge flex circuit is required for a second head gimbal assembly either accessing the other disk surface of a disk, or the other head gimbal assembly mounted on the same actuator arm 50. FIG. 4D is the enlargement of the coupling site 352 of the bridge flex circuit 312, which mirrors FIG. 4B. The probe points pr1+, pr1−, pw1+, pw1−, p302-2, and p302-1 are similar to the corresponding probe points of FIG. 4A. The coupling site 352 is similar, mirroring coupling site 350 of FIGS. 4A and 4B. The slider contacts sr1+, sr1−, wr1+and wr1− are similar to those of FIG. 4A. The control signal bundle s312-1 and s312-2 are similar to those of FIG. 4A.

FIGS. 4A and 4B show a cleavage line 330, which is the approximate place where the test strip is removed from the bridge flex circuit. FIGS. 4C and 4D show the cleavage line 330, which serves the same purpose.

The invention includes the flex circuit assembly of the main flex circuit 220 coupling with at least two of the bridge flex circuits 210-216, as in FIGS. 1 and 2. The making of the flex circuit assembly, includes the following steps. Each of the bridge flex circuits 310 and 312, with its test strip, is probed to confirm the connectivity of the bridge flex circuit. The test strip is removed to create the bridge flex circuit 310 by cutting at the cleavage line 330. Each of the bridge flex circuits, 310-316, are positioned with their respective bridge coupling site 350, 352 aligned with the bridge coupling region 250 of the main flex circuit 220. The aligned main flex circuit and bridge flex circuits are reflow soldered to create the shared coupling of the source control bundle 360.

The other components of the main flex circuit 220 include a preamplifier 222 and a ribbon cable socket 226, as well as passive components, which may include capacitors and resistors. These other components of the main flex circuit 220 may be soldered to the main flex circuit 220 before, during, or after, the bridge flex circuits 210-216.

Making the voice coil actuator of FIG. 3A includes the following steps. The flex circuit assembly of FIGS. 1 and 2, is assembled with the head gimbal assemblies 60-66 and the actuator arms 50-56. The head gimbal assemblies 60-66 include the micro-actuators 300-306, which are electrically coupled with the respective leads of the bridge flex circuits 210-216. This coupling shares the source control bundle 360 of the main flex circuit 220 with the micro-actuator control bundles 310-316 of the bridge flex circuits 210-216.

The voice coil actuator, ribbon cable 1150, and embedded disk controller printed circuit board 1000 of FIGS. 1-3A, are used to assemble the hard disk drive 10. The hard disk drive 10 is made by coupling the ribbon cable 1150 between ribbon cable site 226 and ribbon cable site 230. Ribbon cable site 226 is on the main flex circuit 220. Ribbon cable site 230 is on the embedded disk controller printed circuit board 1000. Ribbon cable 1150 includes a coupling 1016 between a control signal bundle 1014 generated by the piezo driver 1010 and the shared source control bundle 360 of the main flex circuit 220. The piezo driver 1010 is controlled by the servo-controller 1030, which receives feedback 1034 from the channel interface 1140.

The piezo driver 1010 of FIGS. 1 and 2 often includes a Digital to Analog Converter (DAC) providing an initial analog signal, which is often amplified and filtered to generate the states of the control signal bundle 1014. The servo-controller 1030 may control the piezo driver 1010 by controlling the output of the DAC, the amplification gain, and/or the filter parameters. Alternatively, the filtering may be a fixed network preferably containing a combination of resistors, capacitors, and possibly inductors. The amplification may be from a preset amplifier or fixed function driver circuit, or from a programmable gain amplifier.

The feedback 1034 of FIGS. 1 and 2 often includes a Position Error Signal measured and/or estimated at least partly by the channel interface 1140. The channel interface 1140 uses the preamplifier signals of the read-write preamplifier 222, which are part of the couplings provided by ribbon cable 1150. The control of the read-write preamplifier 222 is determined at least in part by the setting of a read bias current Ir_set and a write bias current Iw_set. The determined read channel voltage V_rd of the selected read differential signal pair, generated by the read-write head over the accessed track on the rotating disk surface, is provided by the channel interface 1140. These controls are made, and the read channel voltage is received, by a computer 1100. The computer 1100 accesses 1122 a program system 1128, residing in a memory 1120 to implement the overall operation of the disk drive 10. The computer 1100 further directs 1032 the servo-controller 1030 in its real-time operations, which may entail operational, initialization and/or calibration activities.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

1. A flex circuit interface coupling providing a micro-actuator control bundle to a micro-actuator for positioning a read-write head, for each of at least N of said read-write heads included in a voice coil actuator for a disk drive, comprising:
a source control bundle respectively coupling to said micro-actuator control bundle, for each of said N read-write heads; wherein said N is at least one;
wherein each member of the control bundle collection comprising said source control bundle, and said micro-actuator control bundle, for each of said read-write heads, comprises a first of a control signal;
wherein, for each of said read-write heads, said source control bundle respectively coupling to said micro-actuator control bundle, further comprises:
said first control signal of said source control bundle coupling to said first control signal of said micro-actuator control bundle.

2. The apparatus of claim 1, wherein each member of the control bundle collection comprising said source control bundle, and said micro-actuator control bundle, for each of said read-write heads, comprises a second of a control signal;
wherein, for each of said read-write heads, said source control bundle respectively coupling to said micro-actuator control bundle, further comprises:
said second control signal of said source control bundle coupling to said second control signal of said micro-actuator control bundle.

3. The apparatus of claim 1, wherein said N is at least one.

4. A main flex circuit compatible with the flex circuit constraints of said voice coil actuator of claim 1, comprising:
a bridge coupling region providing said source control bundle coupling to said micro-actuator control bundle on a bridge flex circuit, for each of said N micro-actuators.

5. Said bridge flex circuit compatible with the flex circuit constraints of said voice coil actuator of claim 4, comprising a coupling site matching said bridge coupling region on said main flex circuit.

6. A flex circuit assembly comprising said main flex circuit of claim 5 coupling with each of said bridge flex circuits, sharing said source control bundle with said micro-actuator control bundles, for each of said N read-write heads.

7. Said voice coil actuator, comprising: said flex circuit assembly of claim 6 coupling with said N of said read-write heads and coupling with said N of said micro-actuators, further comprising:
said source control bundle of said main flex circuit shared with said micro-actuator control bundle of said micro-actuator, for each of said N micro-actuators;
wherein each of said read-write heads is at least partly positioned by a separate of said micro-actuators, for each of said N read-write heads.

8. The apparatus of claim 7, wherein said micro-actuator positioning said read-write head, for at least one of said read-write heads, is a member of the collection comprising:
said micro-actuator co-located with said read-write head; and
said micro-actuator non co-located with said read-write head.

9. The apparatus of claim 8, wherein said micro-actuator positioning said read-write head, for each of said read-write heads, is a member of the collection comprising:
said micro-actuator co-located with said read-write head; and
said micro-actuator non co-located with said read-write head.

10. A hard disk drive including said voice coil actuator of claim 7; and a servo-controller providing control of said source control bundle to said main flex circuit coupled to said bridge flex circuits.

11. The apparatus of claim 1, wherein said disk drive uses an optical disk; and wherein said read-write heads at least read data in a track accessed on disk surfaces.

12. A method operating a hard disk drive, comprising the steps of:
generating a control signal bundle by a piezo driver based upon directions provided by a servo-controller to position one of N of read-write heads over a track on a rotating disk surface in said hard disk drive; wherein said N is at least two;
sharing said control signal bundle to a micro-actuator control signal bundle for a separate micro-actuator, for each of said read-write heads;
each of said micro-actuators responding to said micro-actuator control signal bundle to position each of said read-writes, further comprising the step of:
said micro-actuator of said one read-write head, position said one-read-write head of said track on said rotating disk surface.

13. A method making a bridge flex circuit, comprising the steps of:
probing said bridge flex circuit coupled with a test strip providing a probe point for testing for a micro-actuator control bundle through said bridge flex circuit, to create a bridge flex probe of said micro-actuator control bundle; and
removing said test strip near a cleavage line to create said bridge flex circuit, when probing said bridge flex circuit includes said test for said micro-actuator control bundle is successful.

14. The method of claim 13, wherein said micro-actuator control bundle includes at least a first control signal.

15. Said bridge flex circuit as a product of the process of claim 13.

16. A method of making a flex circuit assembly using at least N of said bridge flex circuits of claim 15, comprising the steps of:
using a main flex circuit including a bridge coupling region aligned with a bridge coupling site on said bridge flex circuit, for each of said bridge flex circuits to create an aligned main flex circuit and bridge flex circuits; and
reflow soldering said aligned main flex circuit and bridge flex circuits to create said flex circuit assembly;
wherein said flex circuit assembly includes said main flex circuit providing a source control bundle which is shared with said micro-actuator control bundle of said bridge flex circuit, for each of said bridge flex circuits in said flex circuit assembly;
wherein said N is at least one.

17. Said flex circuit assembly as a product of the process of claim 16.

18. A method of making a voice coil actuator using said flex circuit assembly of claim 17, comprising the step of:
assembling said flex circuit assembly with said N of a head gimbal assembly and at least one actuator arm, further comprising the steps of:
coupling said micro-actuator control bundle of said bridge flex circuit to a micro-actuator included in said head gimbal assembly.

19. Said voice coil actuator as a product of the process of claim 18.

20. A method of making a disk drive using said voice coil actuator of claim 19, comprising the step of:
coupling said voice coil actuator via a ribbon cable to an embedded disk controller printed circuit board; wherein said embedded disk controller printed circuit board includes a piezo driver for driving said source control bundle via said ribbon cable;
wherein said disk drive includes said voice coil actuator coupled via said ribbon cable to said embedded disk controller printed circuit board.

21. Said disk drive as a product of the process of claim 19.

22. Said disk drive of claim 21 is a member of the collection comprising a head disk drive and an optical disk drive.
